(19) United States
(12) Patent Application Publication
(10) Pub. No.: US 2003/0167108 A1
(43) Pub. Date: Sep. 4, 2003

(54) Method for operating a motor vehicle regulation system and device for carrying out said method

(76) Inventors: Christian Albrich von Albrichsfeld, Darmstadt (DE); Thorsten Ullrich, Gernsheim (DE); Bernhard Giers, Frankfurt (DE); Robert Schmidt, Rennerod (DE); Stefan Stolzl, Weinheim (DE); Ralf Junge, Steinbach (DE); Andreas Klein, Bad Homburg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/362,268

(22) PCT Filed: Aug. 22, 2001
(86) PCT No.: PCT/EP01/09701

(30) Foreign Application Priority Data
Aug. 22, 2000 (DE) 100 41 207.6
Nov. 10, 2000 (DE) 100 55 823.2

(51) Int. Cl. G05D 1/00

(52) U.S. Cl. 701/1; 701/70; 701/41

(57) ABSTRACT

The present invention relates to a method of operating a motor vehicle control system with a device adapted to be arranged in a motor vehicle and comprising a nominal value generator, an electric or electronic controller, and a controlled system to which a control element is allocated, especially for the actuation of a controlled brake system, an electric or electromechanical steering system, or similar driver assist systems.

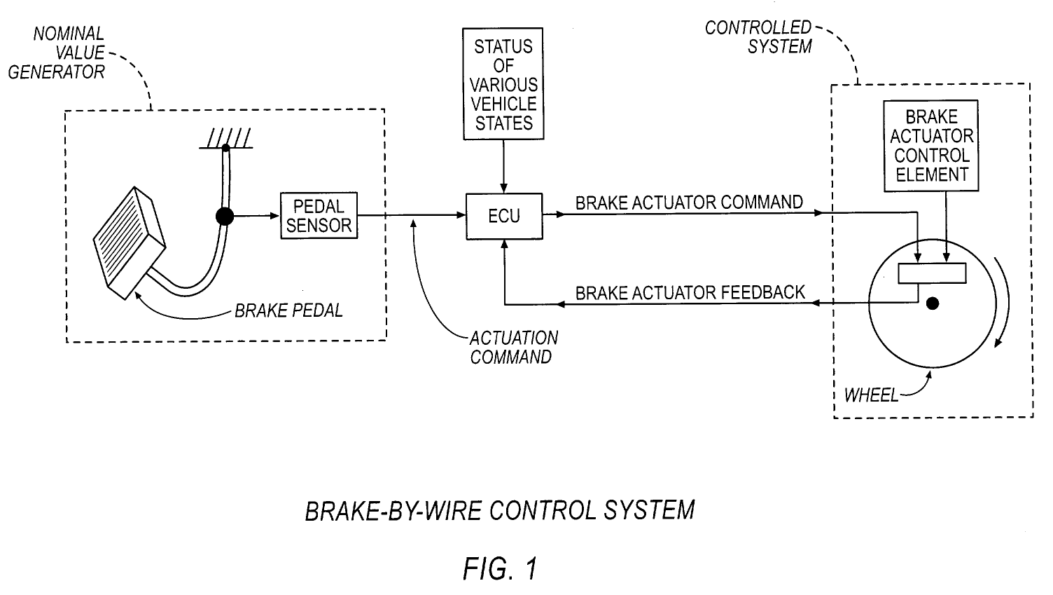

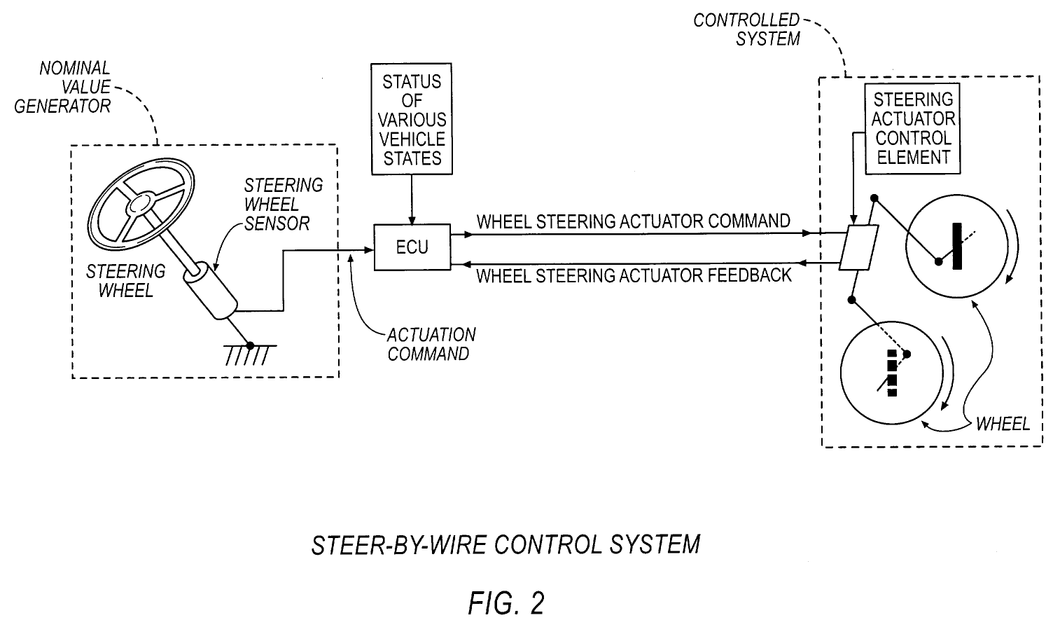

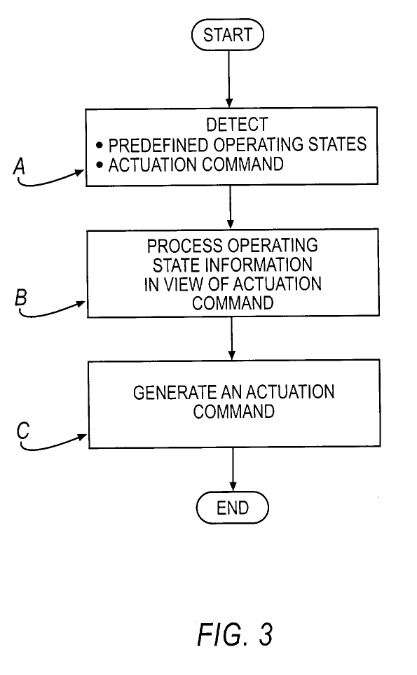

The essence of the invention is that for predefinable operating states the type of a signal characterizing an actuation command is evaluated, and that the effect of the actuation on the device is modified in dependence on the operating state.

### STATE OF THE ART

The present invention relates to a method of operating one or more motor vehicle control systems adapted to be arranged in a motor vehicle and comprising in particular at least one nominal value generator, at least one electric or electronic controller, and at least one controlled system to which at least one control element is allocated, especially for the actuation of a controlled brake system, for the actuation of an electric or electromechanical steering system, or for the actuation of similar driver assist systems.

Motor vehicle control systems are characterized by the feature of assisting a vehicle operator in the control of complex actuating processes. These processes concern in many cases safety-relevant brake actuation processes where a control intervention e.g. in brake-by-wire applications based on a braking command is executed by using auxiliary energy. In electro-hydraulic brake systems (EHB), for example, a hydraulic pump driven by an electric motor is used to supply the system. Special functions such as brake assistant (BA) or driving stability control (ESP) can likewise be depicted.

It is a general trend that the number of electronic components used in motor vehicles is ever increasing, with the result of a growing load on the electrical supply system. It is true that on a long-term basis it is planned to change the supply voltage of the electric system in motor vehicles starting from principally 12 volt or 24 volt to a future supply voltage of e.g. 42 volt or 48 volt. However, such a change of the supply voltage of the electric system is possible only with great effort and structure by exchanging-all consumers, and does not provide any change in the individual nature of consumption of the single consumer or the consumption features of assemblies of the motor vehicle. In addition, it is only possible to change the supply voltage of the electric system in newly developed vehicle models. This modification is out of the question—mainly for cost reasons—for motor vehicles already in mass production and also for old vehicles.

Since assist systems such as a brake system or a steering system fulfill safety-relevant functions, their availability is of prime importance. On the other hand, a high degree of availability is also expected with respect to secondary comfort functions.

Therefore, an object of the present invention is to provide a method of operating a vehicle control system, which safeguards the availability of electrical, in particular safety-relevant, functions on the basis of a limited energy supply. It is desired to improve the energy management of the vehicle control system.

According to the present invention, this object is basically achieved by evaluating the type of an actuation of one or more vehicle control systems in dependence on predefinable operating states or in dependence on marginal conditions characterizing an operating state, and by executing a control intervention in dependence on the evaluation of the actuation.

### ADVANTAGES OF THE INVENTION

Because the way of actuation is evaluated according to the present invention prior to a potential control intervention, it is possible to suppress e.g. control interventions on the basis of unreasonable or improper actuation commands with a view to saving energy, or to execute them in a modified manner. More specifically, actuation commands are not executed slavishly but carried out in a modified fashion in dependence on any operating state and/or marginal conditions. Within the limits of energy management, this allows dealing flexibly with the resources available without jeopardizing the function or availability of individual competing systems. More particularly, (comfort) functions of lower rank will not be disabled when the energy runs short.

The operating method of the present invention also has positive effects on a construction of a device for implementing the method. For example, DE 196 16 538 A1 discloses an electro-hydraulic brake system (EHB brake system) comprising a brake cylinder for the input of a nominal value, a pressure fluid accumulator for taking up pressure fluid, and a pump for increasing the pressure in the pressure fluid accumulator. When the brake system—e.g. during vehicle standstill—is repeatedly actuated at a high frequency (e.g. higher than one hertz), this will cause maximum consumption of pressure fluid and, accordingly, maximum energy consumption on account of frequent pressure increase and pressure reduction operations in the pressure fluid accumulator. Although the case of application described hereinabove is an exception, the capacities of this conventional system must be rated in consideration of this maximum consumption. Consequently, the system is overdimensioned for the predominant number of all conventional cases of application, with the sole purpose of covering the described—absurd—actuation command. This is where the invention takes effect by evaluating the signal characterizing an actuation command, and only subsequently will a control intervention, that may be modified, if necessary, follow on the basis of the evaluation. The present invention is inexpensive because it can mainly be implemented based on software and does not necessitate a complicated exchange of hardware, e.g. in the course of retrofitting. Implementation of advanced control strategies is easily possible by means of a software update.

The present invention not only reduces the stress on the electric system by suppressing or modifying the consequences of defined actuation commands but permits also a reduction of the hardware capacity to be provided. This is because a reduction in costs, overall size and weight of components such as pressure fluid accumulator and pump is rendered possible by relaying an actuation command in a reasonable manner by considering the marginal conditions, so-to-speak interpreted as a control intervention. This consequently restricts any possible misuse.

In a further development of the present invention, the time variation of a signal of the nominal value generator characterizing an actuation command is sensed, and a quantity characterizing the operating condition of the vehicle is sent to the controller for evaluating the signal, and a modification of an output signal of the controller for the control intervention is effected in dependence on the evaluation of the signal. This allows investigating the actuation command and executing e.g. a braking command based on this investigation in a reasonable fashion.

According to a favorable embodiment, quantities are sent to the controller which characterize in particular a filling level of a pressure fluid accumulator or the pressure fluid temperature. This permits applying an operating method, which is particularly economical in terms of pressure fluid and, hence, energy saving, with an e.g. almost empty pressure fluid accumulator and at low pressure-fluid temperatures, without questioning the function of the control system per se.

It is advantageous when the signal modification causes a reduced energy consumption of the control element so that rational dealing with this resource is possible. The reduction in consumption is the result of a reduced current consumption, a reduced intensity (in the operation of the consumer), or is due to a reduction of another parameter that influences the consumption.

According to the invention, the actuating speed and/or the actuating frequency is sensed, and a signal modification occurs when a speed value lies above a limit value or a frequency value lies above a limit value and when a predetermined operating state is detected. Taking these parameters into account is favorable for signal evaluation. The result of the signal modification can be a diminished or delayed or suppressed control intervention with a corresponding answer of the vehicle.

The signal of the nominal value generator is processed by means of a filter, in particular a low-pass filter, in a preferred embodiment of the invention. This processing contributes to eliminating undesirable high-frequency signal components (such as noise, improper actuations).

It is conceivable to process the time variation and/or the amplitude of the signal being supplied to the control element by means of signal modification. Consequently, the output signal of the controller—due to special driving situations/operating states, may differ from a conventional case of actuation (normal case) in terms of variation and amplitude. More specifically, the control signal of the controller may become detached from a nominal value introduced at the driver's end.

It is favorable that the frequency of the modified signal sent to the control element is reduced, delayed or suppressed when there is an actuation command with an actuating frequency in excess of e.g. roughly one hertz and at standstill or approximate standstill of the vehicle. This prevents an unreasonable volume or energy consumption, which is e.g. caused by ‘nervous’ or too rapid pedal actuations.

In a likewise advantageous embodiment of the present invention, it is possible to arrange for a signal modification in the sense of a frequency reduction of the control intervention to e.g. roughly one hertz when there is an actuation command with an actuating frequency of e.g. roughly one hertz and at standstill or approximate standstill of the vehicle.

In another variant of the present invention, the amplitude of the modified signal submitted to the control element (control intervention) is limited to a predefinable limit value when there is an actuating frequency in excess of e.g. roughly one hertz and at standstill or approximate standstill of the vehicle. This renders it possible to avoid overload of the device or of parts of the device due to continued pressure pulsations.

A signal modification can be executed when a change in the operating state or a changed command of the driver is sensed.

According to a device for implementing the method of the invention, there is provision of a means for investigating and/or modifying the time variation of a signal characterizing adjustable in dependence on predefinable operating states, said filter being configured as a software filter in a low-cost manner. The filter principally has a low-pass character so that high-frequency signal components are suppressed or at least hindered. The filter can be adaptive and include a learning mode to adapt to the actuation habits of a vehicle operator.

### DESCRIPTION OF EMBODIMENTS

Further details of the present invention become apparent from the following explanations and examples. The invention will be explained in detail in the following with reference to an example of an electro-hydraulic motor vehicle brake system (EHB brake system), wherein an application in other mechanical/electronic systems such as clutch actuation, engine control, or steering actuation of the by-wire type is possible.

A brake-by-wire brake system comprises an interface (pedal) for the actuation of a nominal value generator (master cylinder) with corresponding sensor equipment for sensing a signal representative of a braking command, further comprising an electric or electronic controller (ECU) with a memorized computer program, and a controlled system (wheel brake) with which preferably several electromagnetically operable hydraulic valves are associated as a control element. Turning away from the hydraulic principle, a fully electromechanical mode of operation on the basis of electromechanical actuators is principally conceivable. The control takes place ‘by-wire’, and suitable safety measures may be provided for an error failure or system failure. In addition, it is advisable for safety reasons to arrange for the signal conditioning and signal processing as well as the corresponding components to be redundant. The assist system detects or monitors beside the condition of the actuation command also the operating states of the vehicle. For example, a distinction can be made between vehicle standstill and driving operation. Depending on the requirement and the correspondingly employed sensor equipment further operating states (e.g. cornering) or a more sensitive resolution (e.g. with respect to driving speed) can be seen. In addition, the nature of a signal characterizing an actuation command is monitored and evaluated so that the effect of the actuation command on the controlled system can be modified in dependence on the operating state. For example, completely absurd actuation commands, which are due to a misuse of the system, can prevail for defined operating states. It is, for example, not plausible when an actuation command comparable to a stutter brake is sensed upon vehicle standstill, said request causing a high energy consumption (due to a high consumption of pressure fluid). To prevent improper actuations of this type, for example, the time variation of a signal of the nominal value generator characterizing the actuation command is sensed and compared with a previously memorized operating state of the motor vehicle, modifiable in other respects. In case the introduced braking command is defined as absurd, signal modification will be effected which is sent to the control element.

A signal modification can effect a reduced energy consumption of the control element. Further, the actuating speed and/or the actuating frequency can be detected by way of the signal of the nominal value generator so that a signal modification is effected if a speed value is in excess of a limit value or a frequency value is in excess of a limit value and a predefined operating state is detected. It goes without saying that the mentioned limit values can be set/memorized in advance.

In detail, the signal modification may have as an effect that a reduced, delayed or suppressed control intervention takes place. The system separates completely from the introduced place. The system separates completely from the introduced braking command in the extreme case. To suppress disturbing components such as high-frequency vibrations (noise) in the sensed signal of the nominal value generator, a filtering operation can be executed by means of a low-pass filter. It is self-explanatory that the rating of the filter influences the control quality and that system stability has priority in any case. Signal modification can be given in the form of processing the variation and/or amplitude of the signal being sent to the control element. Signal processing may be diverse and occur in adapting to the respective circumstance/operating state. For example, the frequency of the signal sent to the control element can be reduced, delayed, or suppressed when there is an actuation frequency in excess of e.g. roughly one hertz and at standstill or approximate standstill of the vehicle. Further, it is possible that a signal modification in the sense of a frequency reduction to e.g. roughly one hertz is arranged for when there is an actuation frequency in excess of e.g. roughly one hertz and at standstill or approximate standstill of the vehicle. It is conceivable in an alteration to limit the amplitude of the signal being sent to the control element to a predetermined limit value when there is an actuation frequency in excess of e.g. one hertz and at standstill or approximate standstill of the vehicle.

It is arranged for that signal modification is discontinued when a change in the operating state (e.g. change from stationary to riding vehicle) or a changed command of the driver (e.g. change from high-frequency actuation to slow braking) is detected.

### EXAMPLES

Variant 1: When a controlled brake system, e.g. an EHB brake system, is actuated at a frequency (e.g. three hertz) higher than appropriate in a predetermined situation (e.g. one hertz at vehicle standstill), the signal of the nominal value generator is filtered (e.g. by a low-pass filter of first order).

Variant 2: In the event of actuation at a frequency (e.g. three hertz) higher than appropriate in a predetermined situation (e.g. one hertz at standstill) the amplitude of the modified signal is reduced to a situation-responsive value (modified nominal braking pressure, modified nominal braking torque, modified nominal deceleration, etc.) or to an associated, correspondingly determined value (e.g. nominal deceleration of 0.3 g at standstill).

Variant 3: In the event of actuation at a frequency (e.g. three hertz) higher than appropriate in a predetermined situation (e.g. one hertz at standstill) the modified signal is reduced to a second predetermined situation-responsive frequency (e.g. one hertz at standstill). This means when the driver actuates with three hertz at standstill, the controller will output a frequency of one hertz for the specification of the nominal values of wheel pressure.

The variants are preferably executed so that the haptic feedback to the driver is minimal and, hence, remains largely unnoticed by the driver.

The execution of the signal modification is discontinued when, for example, either the actuation frequency per time unit decreases again (e.g. lower than/equal to one hertz) or when it is detected that the driver wishes to drive off. This is, for example, possible by means of evaluation of a gas pedal actuation or of the engine torque. If a wheel braking pressure (residual brake torque) corresponding to variant 2 prevailed in The invention can also be employed in the case of high-frequency disturbances when e.g. the actuating unit with a high frequency issues a driver's request, even if the driver himself does not actuate. The reason for this can be a rough road section, for example, or if a restoring spring in a pedal-actuating unit becomes weaker due to fatigue so that on account of a pulsating brake pedal on a bumpy road, braking commands are erroneously detected (frequency e.g. higher than three hertz—pedal pulsates to and fro). When it is detected that a braking command cannot originate from the driver (e.g. actuation above five hertz), the signal is suppressed completely e.g. by means of filtering (low-pass filter). It may be arranged for that the filter parameters (e.g. time constant) are adjustable, an adaptation having proven to be especially favorable. Within the frame of an adaptation, filter parameters are varied in dependence on defined operating states or actuating states. An essential operating state in this connection is the filling level of the pressure fluid accumulator, and a stronger filtering (i.e. intervening at lower frequencies) is advisable when the pressure fluid accumulator is almost empty. It is possible, on the other hand, to perform a filtering operation that is reduced in comparison thereto when the accumulator is filled completely. A reduced filtering (reduction of the time constant) results with rising filling level. When conditions with contradicting consequences coincide such as in the event of a low pressure-fluid accumulator filling level and a braking command, the pressure fluid accumulator filling level has priority, i.e., strong filtering takes place.

It is further possible to determine the direction of the actuation command and, starting from the direction of actuation, provide different signal modifications, especially filtering operations. To improve the actuating comfort, a reduced filtering is performed in a brake system when braking is effected than when the braking effect is neutralized.

The consideration of the filling level of the pressure fluid accumulator may further be provided combined with the consideration of the direction of actuation so that, with a low filling level and withdrawal of the braking command, a stronger filtering takes place than with a high filling level and brake actuation. Further, a combination of considering the filling level with the currently existing wheel braking pressure is possible, and filtering is adjusted so that a brake release command compared to a braking command is realized in a decelerated manner.

A filter provided with a learning mode and permitting an adaptation of filter parameters to the actuation habits of a vehicle operator renders possible a particularly simple operation. The learning mode is permanently activated so that e.g. a change of driver can be detected in an automated fashion and the modified actuation habits can be taken into consideration in the controller.

The present invention is applicable to all electric actuating devices in motor vehicles, for example, to a steer-by-wire or a brake-by-wire device.

The invention achieves a reduction of the consumption of fluid (hydraulics) or of electric energy (current), which, in turn, allows a low-cost design of the system.

1. Method of operating one or more control systems adapted to be arranged in a motor vehicle and comprising in particular at least one nominal value generator, at least one electric or electronic controller, and at least one controlled system to which at least one control element is allocated, especially for the actuation of a controlled brake system, for the actuation of an electric or electromechanical steering system, or for the actuation of similar driver assist systems,
characterized in that for predefinable operating states the type of a signal characterizing an actuation command is evaluated, and that the effect of the actuation command on the controlled system is modified in dependence on the operating state.

2. Method as claimed in claim 1,
characterized in that the time variation of a signal characterizing an actuation command is detected, that a quantity characterizing the vehicle operating state is sent to the controller for evaluating the signal, and in that a modification of an output signal of the controller for the control intervention is effected in dependence on the evaluation.

3. Method as claimed in claim 1 or 2,
characterized in that a quantity characterizing a filling level of a pressure fluid accumulator is sent to the controller.

4. Method as claimed in claim 1 or 2,
characterized in that a quantity characterizing the pressure fluid temperature is sent to the controller.

5. Method as claimed in claim 2,
characterized in that the signal modification effects a reduced energy consumption of the control element due to a reduced current consumption, reduced intensity, reduced duty cycle, or due to reduction of another parameter.

6. Method as claimed in any one or more of the preceding claims,
characterized in that the actuating speed and/or the actuating frequency is detected, and that a signal modification occurs when a speed value lies above a limit value, or a frequency value lies above a limit value, and/or when a predetermined operating state is detected.

7. Method as claimed in claim 6,
characterized in that the result of the signal modification is a diminished or delayed or suppressed control intervention.

8. Method as claimed in any one or more of the preceding claims,
characterized in that the signal of the nominal value generator is filtered by means of a low-pass filter.

9. Method as claimed in any one or more of the preceding claims,
characterized in that defined operating states and/or defined actuating states are taken into consideration for the adjustment of filter parameters or for the adaptation of filter parameters.

10. Method as claimed in any one or more of the preceding claims,
characterized in that the variation and/or the amplitude of the signal being sent to the control element are processed.

11. Method as claimed in any one of claims 6 to 10,
characterized in that a signal modification is arranged for in the sense of a frequency reduction of the control intervention to e.g. roughly one hertz when there is an actuation command with an actuating frequency in excess of e.g. roughly one hertz and at standstill or approximate standstill of the vehicle.

12. Method as claimed in any one of claims 6 to 11,
characterized in that the amplitude of the control intervention is limited to a predefined limit value when there is an actuation command with an actuating frequency in excess of e.g. roughly one hertz and at standstill or approximate standstill of the vehicle.

13. Method as claimed in claim 6,
characterized in that the signal modification is discontinued when a change in the operating state or a change in the driver's command is sensed.

14. Device for implementing the method as claimed in claim 1, comprising at least one nominal value generator, at least one electric or electronic controller, and at least one controlled system to which at least one control element is allocated, especially for the actuation of a controlled brake system, an electric or electromechanical steering system, or similar driver assist systems,
characterized in that a means is provided for investigating and/or modifying the time variation of a signal characterizing an actuation command.

15. Device as claimed in claim 14,
characterized in that the means is an adjustable filter.

16. Device as claimed in claim 15,
characterized in that the means is an adjustable low-pass filter.

17. Device as claimed in claim 16,
characterized in that an adaptive filter is provided.

18. Device as claimed in claim 15,
characterized in that the filter includes a learning mode for adapting filter parameters to the actuating habits of a vehicle operator.
